(19) United States
(12) Patent Application Publication
(10) Pub. No.: US 2025/0296771 A1
(43) Pub. Date: Sep. 25, 2025

(54) Dual Lid Cover for a Wheeled Trash Bin

(71) Applicant: Anthony Jeremiah Bayne, lomita, CA (US)

(72) Inventor: Anthony Jeremiah Bayne, lomita, CA (US)

(21) Appl. No.: 19/057,960

(22) Filed: Feb. 19, 2025

Related U.S. Application Data
(60) Provisional application No. 63/567,943, filed on Mar. 21, 2024.

(51) Int. Cl. B65F 1/16

(52) U.S. Cl. CPC B65F 1/1607; B65F 1/1646

(57) ABSTRACT

A cover for a two-wheeled trash bin, comprising two lids. A first lid that is useable to cover an uncover the bin's cavity, and a second lid that is useable to cover and uncover a hole in the first lid. The lids open in different directions. The second lid and its opening direction provide ease of use in depositing trash into the bin and improved access to the bin's main handle and wheels to roll the bin out to a curb for trash collection. The cover may include a latch to keep the second lid closed when the bin is inverted. When closed, the second lid may lie on top of the first lid or lie within a cavity of the first lid so that the top surface of the first and second lid are substantially level.

### FEDERALLY SPONSORED RESEARCH OR DEVELOPMENT

Not applicable.

### FIELD OF THE INVENTION

The present invention relates to a cover for a trash bin. More particularly, the invention relates to an improved dual lid cover for a two wheeled trash bin that provides ease of use in depositing trash into a bin and better access to the bin's main handle to roll the bin out to a curb on trash collection day.

### BACKGROUND OF THE INVENTION

Many residential outdoor two wheeled trash bins (also known as “trash cans”) have two wheels and a main horizontal handle on the back of the trash bin that allows a user to tilt the trash bin back over the wheels and roll the bin to the curb for trash pickup. The bin's frequently have a cover that is a single lid to cover the bin's single cavity. The cover often includes integrally formed hinges with C-shaped ends that attach to the bin's main horizontal handle by snapping the hinge ends onto the handle, or by bolting them to the handle with a plate that closes off the open space of the C-shaped end. Alternatively, the hinges may each have a hole that the main handle is passed through (to act as a pin) to connect the cover to the bin. A user can manually swing the attached cover open up to (approximately) 270 degrees to place trash inside the bin.

Users employ the handle to steer the bin out to the curb and position its front toward the street, so that when a trash collection truck (e.g., automated side loader (ASL) garbage truck) operator uses the ASL's claw to grab and invert the bin over the ASL's hopper, gravity will cause the lid to swing open in a rotational movement to empty the trash in a way that the falling trash makes minimal contact with the lid as it falls into the hopper.

After the bin has been emptied and placed back on the curb, the user wheels the empty trash bin to a location where the bin remains until the next trash collection day. For example, the location may be an empty area proximate to an exterior wall on the side of the user's home. The user often then chooses to: (1) Position the bin so that the bin's front is proximate to the wall, so that it is easy to roll the bin out to the curb on the next trash collection day, or (2) Position the bin so that the bin's main handle is proximate to the wall, so that it is easy to deposit trash into the bin.

With the bin's front proximate to a wall, the bin's main handle and wheels are easily accessed by the user when it is time to roll the bin out for trash collection. The user can brace a wheel with the bottom of his foot and tilt the bin back by pulling the main handle to shift the bin's weight over the wheels so it can be rolled out to the curb.

A problem with the bin front proximate to the wall position is that to deposit trash, the user must extend his arm to reach the front of the cover's lid (that is near the wall) and then pull the lid, in a front to back rotational movement to open it. Reaching the lid's front may be difficult when the user is carrying a full trash bag (e.g., 14-gallon trash bag) in the opposite hand or has short arms. Also, a bin in this position, especially when the bin is between other bins, may require that the user open the lid widely (e.g., greater than ninety degrees) to access the bin's cavity to deposit trash into the bin. When the lid is opened widely the user may also have to lift the lid up to close it.

When the user positions the bin so that the bin's main handle is proximate to the wall, so that the bin's front points away from the wall, the user can easily deposit trash by opening the front of the lid up in a single front to back rotational movement. The user doesn't have to reach across the cover to grab the front of the lid and then pull it back. Also, the user can open the lid just enough (e.g., less than ninety degrees) to deposit trash into the cavity of the bin and allow gravity to close it.

A problem with the bin handle proximate to the wall position is that when the bin becomes full it is often difficult for the user to drag the bin away from the wall to spin it around to access the main handle so it can be rolled out to the curb for trash collection. This is especially true if the bin is over filled or sandwiched between other bins.

One attempt to remedy this problem is to have a second handle on the front of the bin (e.g., molded into the body or attached separately) to grab and drag the bin forward, so that a user can access the main handle. While the secondary handle gives a user a handhold to pull the bin away from the wall, the full bin must still be moved away from the wall to access the main handle at the back of the bin.

Therefore, there remains a need to allow the convenience of easy access to a bin's main handle to roll the bin to the curb on trash collection day, and ease in depositing trash into the bin.

### SUMMARY OF CERTAIN INVENTIVE ASPECTS

To solve the aforesaid problems, disclosed is a new dual lid trash bin cover for an outdoor, two wheeled trash bin whose wheels and main handle are located at the back of the bin. The cover comprises two lids. The first lid is removably attachable to a bin's main handle, or to another location proximate to the back of the bin, to be manually opened in a first direction, and includes a hole in its top. The first direction is a front to back rotational movement. The first lid can be opened at least ninety degrees. The second lid is removably attachable to the first lid and can be manually opened in a rotational movement in a different, second direction (e.g., back to front, left to right, etc.). The second lid may be opened to one hundred and eighty degrees. It is intended that the cover be used for an outdoor two-wheeled trash bin, but it may be used for other types of trash bins that are cumbersome to handle when full.

Alternatively, the second lid may be removably attachable to an interior wall of the hole in the first lid, a slot appurtenant thereto, or to the bottom of the first lid (e.g., by a hinge arm attached to a hinge base member). In this alternative configuration, the second lid sits in a space of the first lid when the second lid is closed to cover the hole in the first lid, so that second lid's top surface is substantially level with the top surface of the first lid.

Using the new bin cover, a user can place the empty bin's front proximate to (for example) an external wall of the user's home and deposit trash into the bin through the first lid's hole. The second lid is located on top of the first lid and may be opened by a user in a rotational motion (e.g., back to front) to uncover the hole in the first lid. In this way, the user does not have to spin the bin around to place the bin's main handle near the wall for the easy deposit of trash into a two wheeled trash bin. Further, since the main handle and wheels are pointing away from the wall, it makes it easier for the user to take a full bin to the curb on trash collection day.

The first and/or second lid of the cover may have a latch, or other fastening apparatus, to keep the second lid closed when the trash bin is inverted, and the cover swings open to empty its contents into an ASL hopper on trash collection day.

In a preferred embodiment, the invention comprises a trash bin cover for a two wheeled trash bin, the bin comprising a cavity for trash, the cover comprising a second lid removably attachable to a first lid when the first lid is useable to cover the bin's cavity; and the second lid is used to cover and uncover a hole in the first lid to enable a user to deposit trash through the first lid's hole into the cavity. The second lid, when attached to the top of the first lid and closed, may be substantially parallel to the first lid.

In an alternate embodiment, the invention comprises a cover for a two wheeled trash bin. The cover comprises two lids. A first lid that further comprises a hole in its top, a hinge base member of a unified one-piece construction with the first lid, and a second lid to cover and uncover the hole in the first lid, wherein the second lid comprises a hinge arm, of a one-piece unified construction with the second lid, that is removably attachable to the hinge base member of the first lid.

In yet another alternate embodiment, the invention comprises an auxiliary second lid for a wheeled trash bin. The auxiliary second lid is useable to cover and uncover a hole in a first lid for a two wheeled trash bin and the auxiliary second lid comprises a hinge arm of a unified one-piece construction with the auxiliary second lid that is removably attachable to the first lid.

Other objectives and aspects of the invention will become apparent from the following detailed description, taken in conjunction with the accompanying drawings, which illustrate, by way of example, the features in accordance with embodiments of the invention.

To the accomplishment of the above and related objects, the invention may be embodied in the form illustrated in the accompanying drawings, attention being called to the fact that the drawings are illustrative only, and that changes may be made in the specific construction illustrated, and the manner described, that are within the scope of the appended claims. Thus, the breadth and scope of the present invention should not be limited by any of the above-described exemplary embodiments.

### BRIEF DESCRIPTION OF THE DRAWINGS

FIG. 1 is a perspective view of a preferred embodiment of the invention of a dual lid cover for a wheeled trash bin with the second lid open.

FIG. 2 is a top view of a dual lid cover for a wheeled trash bin with the second lid closed.

FIG. 3. is a bottom view of FIG. 2?

FIG. 4 is a right-side view of FIG. 2 with the second lid open.

FIG. 5 is a left-side view of FIG. 2 with the second lid open.

FIG. 6 is a rear view of FIG. 2 with the second lid open.

FIG. 7 is a front view of FIG. 2 with the second lid open.

FIG. 8 is an elevated perspective view of an alternate embodiment of the invention including a two wheeled trash bin and a cover including two lids that are closed.

FIG. 9 is a rear quarter perspective view of FIG. 8 including a cover with an open first and second lid.

FIG. 10 is an elevated rear quarter perspective view of a two wheeled trash bin with the front proximate to a wall and the second lid open while a user drops trash into the bin through a hole in the first lid.

FIG. 11 is a perspective view of an alternate embodiment of the invention of a cover for a wheeled trash bin with the second lid opened to the left side of the first lid and a latch.

FIG. 12 is an elevated front quarter view of a two wheeled trash bin with a cover including two lids and a second lid attached to the top of a first lid's left side that are both closed.

FIG. 13 is an elevated rear quarter perspective view of FIG. 12 with both lids open.

FIG. 14 is an elevated front quarter perspective view of an auxiliary second lid and hinge arm of a unified one-piece construction.

FIG. 15 is an elevated perspective view of a first hollowed lid for an auxiliary lid.

FIG. 16 is an elevated perspective view of an open auxiliary second lid attached to a first hollowed lid.

FIG. 17 is a top view of a FIG. 16 with the auxiliary lid closed.

### DETAILED DESCRIPTION

The present invention solves the aforesaid problems by providing a new dual lid trash bin cover that gives a user access to the waste bin's main handle for easy movement of the bin and ease in depositing trash into the bin when the bin's front is proximate to a wall or other fixture. These and other features, aspects and embodiments of the invention will be described in more detail below.

The presence of broadening words and phrases such as “one or more,” “at least,” “but not limited to”, or other like phrases, shall not be read to mean that the narrower case is intended, or required, where such broadening phrases may be absent.

The following detailed description is directed to certain specific embodiments of the invention. However, the invention can be embodied in a multitude of diverse ways as defined and covered by the claims. In this description, reference is made to the drawings wherein like parts are designated with like numerals throughout.

The objects and features of the present invention will become more fully apparent from the following description and appended claims, taken in conjunction with the accompanying drawings. Understanding that these drawings depict only typical embodiments of the invention and are not to be considered limiting of its scope, the invention will be described and explained with additional specificity and detail using the accompanying drawings.

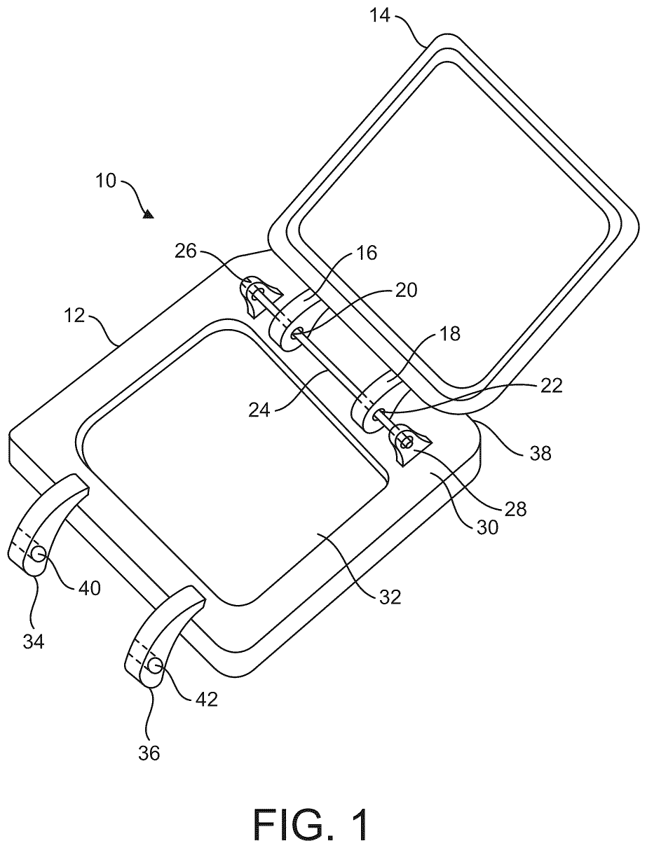

FIG. 1 shows a perspective view of a preferred embodiment of a dual lid cover 10 for a wheeled trash bin, comprising a first lid 12 and a second lid 14 that is open. The second lid 14 is attached to the first lid 12 and the second lid 14 may be manually rotated open from back to front. The lids 12 & 14 may be made of blow-molded plastic, a different material (e.g., recycled aluminum), or by a combination of them. Also, the lids 12 & 14 may be manufactured by a different process. The second lid 14 may include two hinge arms 16 & 18 that are of a one-piece unified construction with the second lid 14. Alternatively, the second lid 14 may only have a single hinge arm, or other attachment means (e.g., the two lids 12 & 14 are zip-tied together). The hinges 16 & 18 may further each include a hole 20 & 22 that a pin 24 is inserted through to hold the hinges 16 & 18 to base members 26 & 28 that are on the top 30 of the first lid 12. In a preferred embodiment, the hinge base members 26 & 28 are of a one-piece unified construction with the first lid 12.

The second lid 14 is manually opened and closed to uncover and cover a hole 32 in the first lid 12 to deposit trash into a two-wheeled trash bin that the cover 10 is attached to by hinges 34 & 36. The hinges 34 & 36 preferably connect to the bin's main handle located at the back of the bin (not shown). Alternatively, the hinges 34 & 36 may attach to a hinge base member(s) located on the trash bin. In a preferred embodiment the hinges 34 & 36 are of a one-piece unified construction with the cover's 10 first lid 12.

The hole 32 in the first lid 12 is preferably large enough to accommodate a full, tall kitchen bag (e.g., a 14-to-30-gallon trash bag), but at least large enough to accommodate a full, small trash bag (e.g., 4-gallon trash bag). When the trash bag, or other object, is larger than the hole 32 in the first lid 12, a user can open the first lid 12 to deposit the object into an attached wheeled trash bin. In this way a user can conveniently deposit most trash into a two wheeled trash bin without opening the first lid 12 or without having to turn a bin to face away from a wall.

The hinge base members 26 & 28 on the first lid 12 are preferably located proximate to the first lid's 12 front edge 38. The first lid's 12 hinges 34 & 36 may include holes 40 & 42 to allow the main handle (not shown) of a wheeled trash bin to be inserted through them 40 & 42 to act as a pin 24 to secure the first lid 12 to the bin and provide an axis for the first lid 12 to be manually rotated open front to back to (approximately) 270 degrees.

Alternatively, the hinge arms 16, 18, 34, and 36 may attach to a pin 20 or bin main handle in a different manner. For example, the hinge arms may be snap fitted, as taught in “Refuse container lid with integrally-formed hinges” [sic], Prout, et al., U.S. Pat. No. 5,167,351-A.

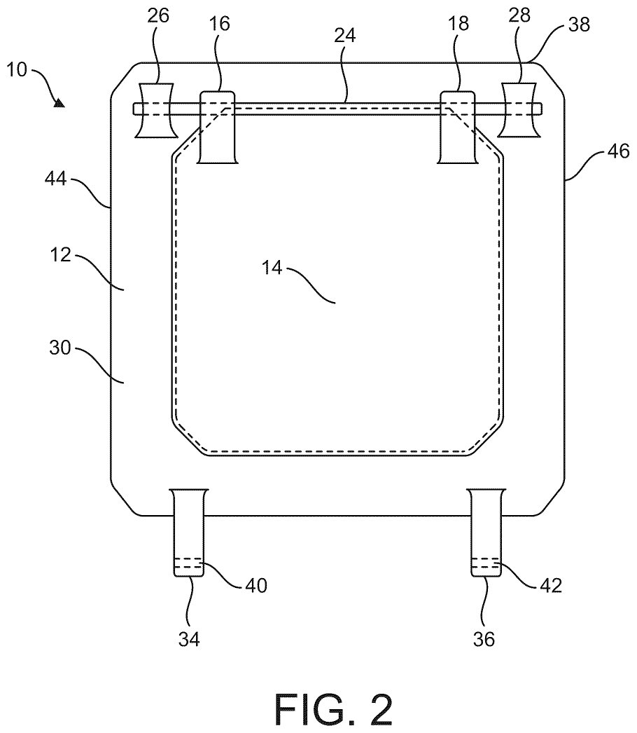

FIG. 2 is a top view of a dual lid cover 10 for a wheeled trash bin with the second lid 14 closed on the top 30 of the first lid 12. The second lid's 14 hinges 16 & 18 are held by a pin 24 that connects the second lid 14 to base members 26 & 28 of the first lid 12. The base members 26 & 28 are preferably located proximate to the front edge 38 of the first lid 12 but alternatively may be located to the left side 44 or right side 46 of the first lid 12, or another location that is not proximate to the back of the first lid 12. The first lid 12 and second lid 14 do not share a common axis and each open in a different direction. The first lid's 12 hinges 34 & 36 are preferably of a one-piece unified construction with the first lid 12 and include a hole 40 & 42 for a main handle of a two-wheeled trash bin to be inserted through to join the first lid 12 to the bin (not shown).

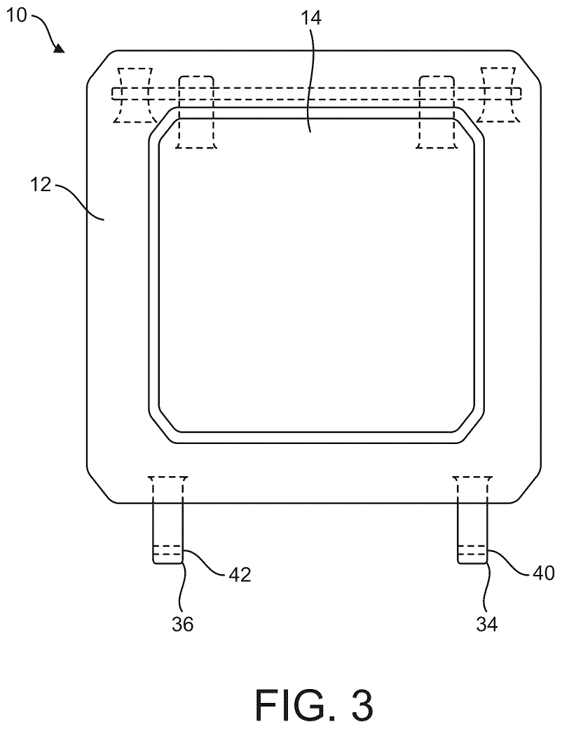

FIG. 3. is a bottom view of the dual lid cover 10 in FIG. 2 showing the second lid 14 closed on the first lid 12. The first lid 12 includes two hinges 34 & 36 of a unified one-piece construction with the first lid 12, and each hinge 34 & 36 includes a hole 40 & 42 to receive the main handle of a two wheeled trash bin.

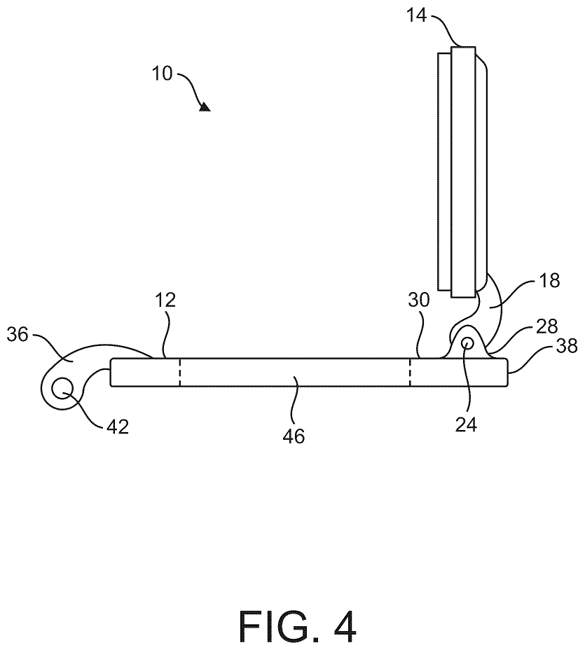

FIG. 4 is a right-side view of the dual lid cover 10 in FIG. 2 with the second lid 14 opened from back to front. A hinge arm 18 of the second lid 14 can be seen held by a pin 24 to a hinge base member 28 that is located on top 30 of the first lid 12 proximate its front edge 38. The first lid 12 preferably attaches to a main handle of a two wheeled trash bin (not shown) by one or more hinges 36 that include a hole 42 that the main handle of a two wheeled trash bin can pass through to act as a pin 24 to rotate the first lid 12 open and closed. The top 30 and sides (46 right side shown) of the first lid 12 preferably cover the mouth of the trash bin to keep animals and elements (e.g., rain) out of the bin. The cover's 10 first lid 12 preferably overlaps the bin's cavity rim to prevent trash odors from escaping the bin.

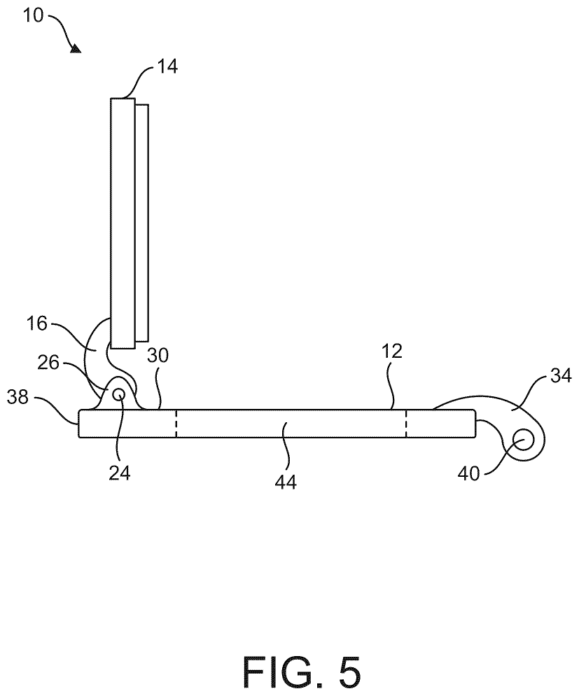

FIG. 5 shows a left side view of the dual lid cover 10 in FIG. 2 with the second lid 14 opened from back to front. The second lid's 14 left side hinge arm 16 can be seen held by a pin 24 to a hinge base member 26 that is located on top 30 of the first lid 12 proximate its front edge 38. The first lid 12 preferably attaches to a main handle of a two wheeled trash bin by one or more hinges 34 that includes a hole 40 that the handle can be inserted through to act as a pin 24 to manually rotate the first lid 12 open and closed. The top 30 and sides (44 left side shown) of the first lid 12 preferably completely cover the mouth of a two-wheeled trash bin to keep animals and elements (e.g., rain) out. The cover 10 preferably completely overlaps the bin's rim to prevent trash odors from escaping the bin.

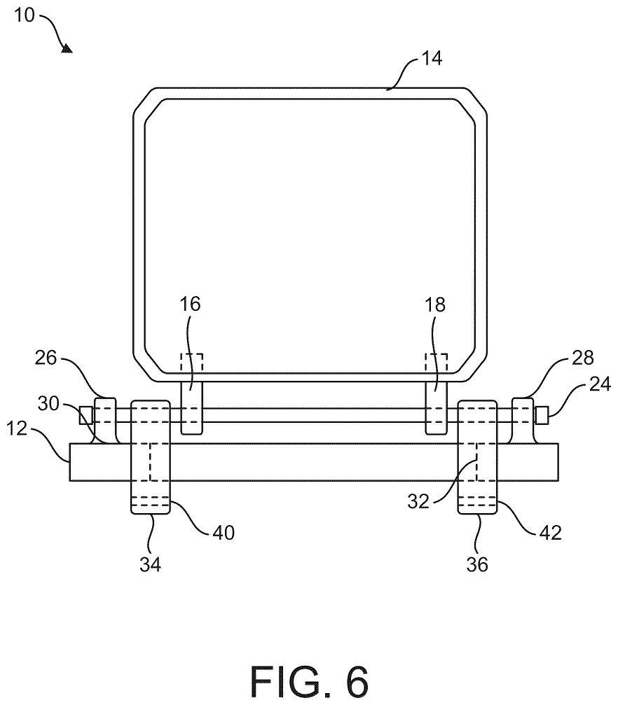

FIG. 6 is a rear view of the dual lid cover 10 in FIG. 2 with the second lid 14 attached to the first lid 12 and rotated open from back to front. The second lid 14 is attached to the first lid 12 by two hinge arms 16 & 18 that are of a one-piece unified construction with the second lid 14. The first lid 12 includes hinge base elements 26 & 28 located on top 30 that hold a pin 24 that is inserted through the holes 20 & 22 in the second lid's 14 hinge arms 16 & 18 to allow the second lid 14 to rotate open and close over the hole 32 in the first lid 12. The first lid 12 includes two hinge arms 34 & 36 of a one-piece unified construction with the first lid 12 that include holes 40 & 42 to attach to the main handle, located at the back of a two wheeled trash bin (not shown).

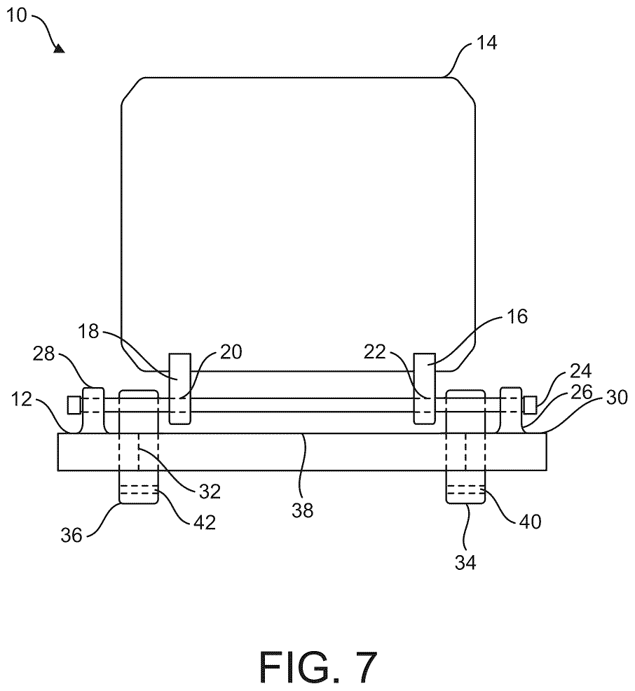

FIG. 7 is a front view of FIG. 2 with the second lid 14 attached to a first lid 12 and rotated open from back to front. The second lid's 14 two hinge arms 16 & 18 attach to a pin 24 that is held in place by hinge base members 26 & 28 that are on top 30 of the first lid 12 and proximate to its front edge 38. The hinge arms 16, 18, 34 & 36 allow the first lid 12 and second lid 14 to rotate open in different directions. The second lid 14 may be manually opened approximately 180 degrees to allow a user to deposit trash through the hole 32 in the first lid 12 when the first lid 12 is closed over the cavity of a two-wheeled trash bin. Each of the hinge arms 16, 18, 34 & 36 include a hole 20, 22, 40 & 42 to allow a pin 24 (or the main handle of a two wheeled trash bin to act like a pin 24) to be inserted through them to act as an axis for each lid 12 & 14. Alternatively, the hinge arms 16, 18, 34 & 36 may snap onto a pin 24 or main handle.

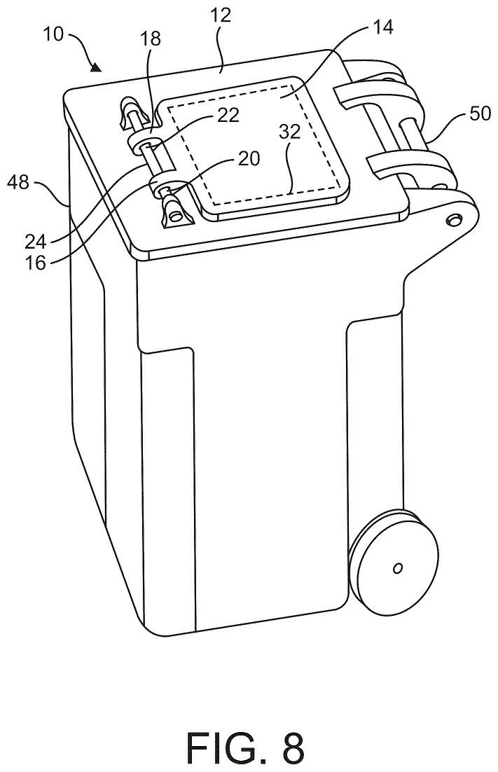

FIG. 8 shows an elevated perspective view of dual lid cover 10 including a first lid 12 and second lid 14 that are closed and are substantially parallel when closed. The cover 10 is attached to a two-wheeled trash bin 48 by the bin's 48 main handle 50 that acts as a pin 24 to form an axis to allow the first lid 12 to be opened from front to back up to approximately 270 degrees. The second lid's 14 hinges 16 & 18 are preferably of a one-piece unified construction with the second lid 14 and include holes 20 & 22 to connect to a pin 24, so that the second lid 14 may be rotatably opened from back to front to uncover a hole 32 in the first lid 12 to deposit trash into the bin 48.

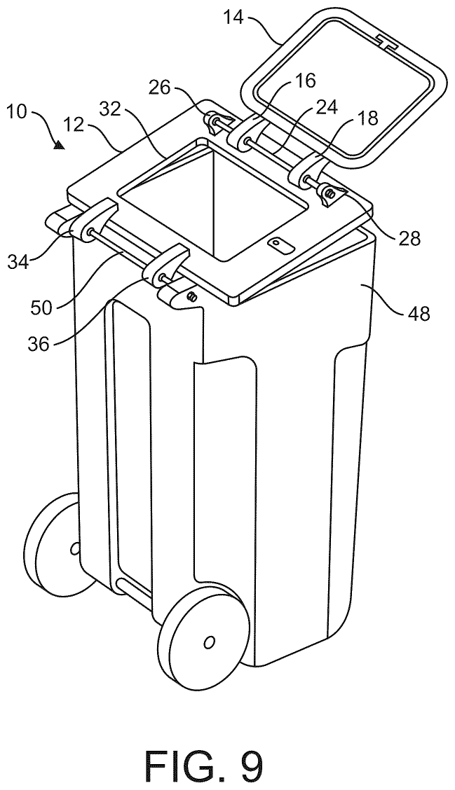

FIG. 9 shows a rear quarter perspective view of FIG. 8 including a dual lid cover 10 with an open first 12 and open second lid 14. The cover's 10 first lid 12 is attached to a two wheeled trash bin 48 by hinge arms 34 & 36 attached to the bin's 48 main handle 50. The second lid 14 is attached to the first lid's 12 hinge base members 26 & 28 by hinge arms 16 & 18 held by a pin 24. The first 12 and second 14 lids open in different directions. The second lid 14 covers/uncovers a hole 32 in the first lid 12 so that user can deposit trash into the bin 48 when the bin's 48 front is proximate to a wall or fixture (not shown) without opening the first lid 12.

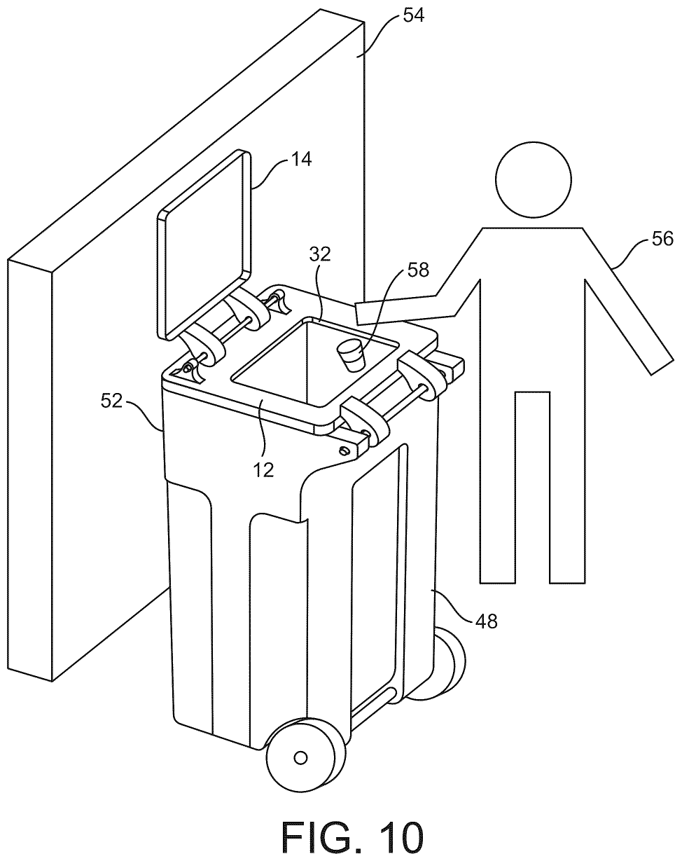

FIG. 10 is an elevated rear quarter perspective view of a two wheeled trash bin 48 with the bin's 48 front 52 proximate to a wall 54 while the first lid 12 is closed and the second lid 14 is open as a user 56 drops trash 58 into the bin 48 through a hole 32 in the first lid 12. The first lid's 12 hole 32 is preferably large enough to accommodate a full, tall kitchen trash bag (e.g., 14-to-30-gallon trash bag).

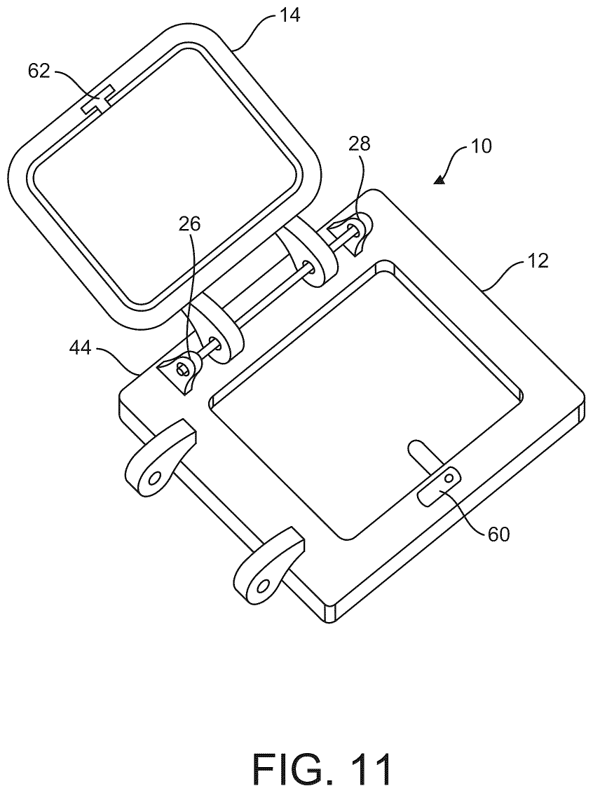

FIG. 11 is a perspective view of an alternate embodiment of a dual lid cover 10 for a wheeled trash bin (not shown) with the second lid 14 opened toward the left side 44 of the first lid 12. The cover 10 may include a latch 60 and a catch 62 integral to the material of a lid (12 and/or 14) to keep the second lid 14 shut when the cover 10 is inverted. In this embodiment the hinge base members 26 & 28 are proximate to the left side 44 of the first lid 12.

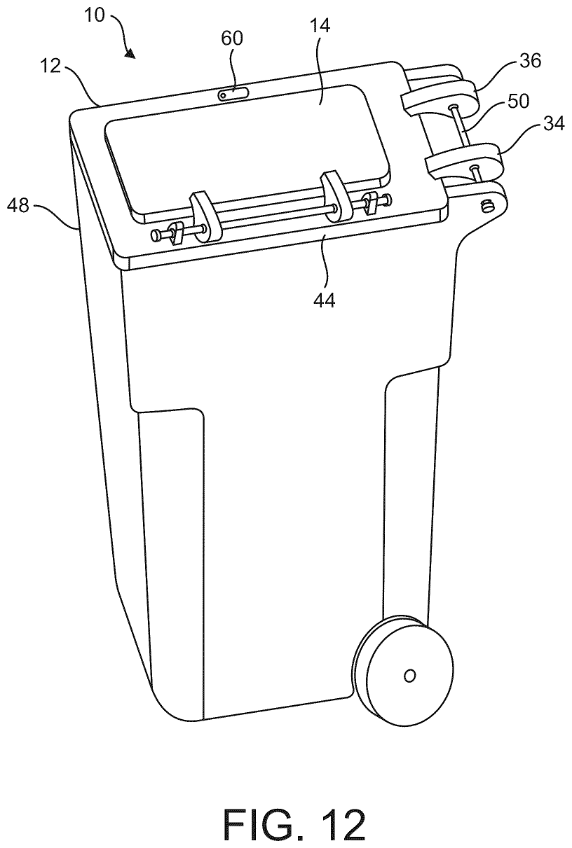

FIG. 12 is an elevated front quarter view of a two wheeled trash bin 48 with a dual lid cover 10 including a first lid 12 and an attached second lid 14 that are closed. The first lid 12 and second lid 14 are substantially parallel when closed. The second lid 14 is attached to the first lid 12 proximate to the first lid's 12 left side 44. The first lid 12 is attached to the main handle 50 by hinge arms 34 & 36. A latch 60 may be attached to the first lid 12 to secure the second lid 14 closed. Alternatively, the latch 60, or other securing mechanism, can be attached to another part of the cover 10.

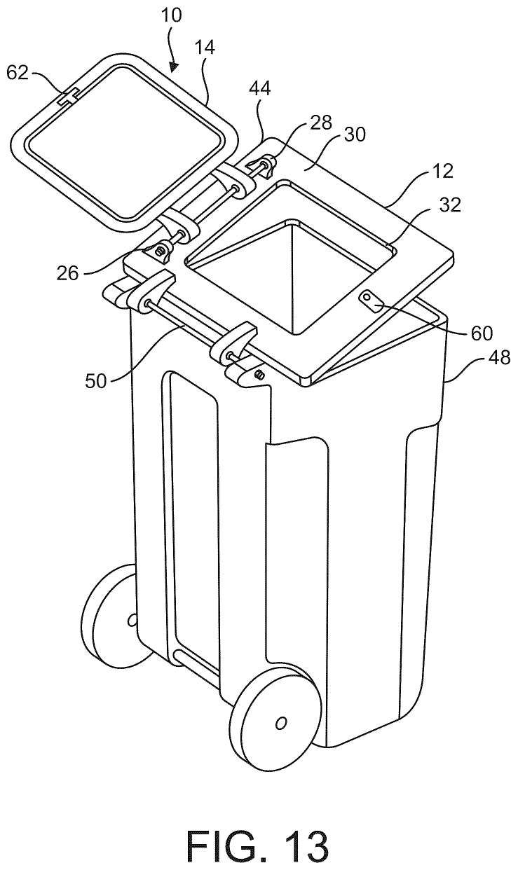

FIG. 13 is an elevated rear quarter perspective view of FIG. 12 with a dual lid cover 10 attached to a two-wheeled trash bin 48. The cover 10 includes a first lid 12 and second lid 14 that are both shown rotated open in different directions. Since the hinge base members 26 & 28 are on the top 30 left side 44 of the first lid 12, the second lid 14 opens toward the first lids' 12 left side 44 to uncover the hole 32 in the top 30 of the first lid 12. The first lid 12 may include a latch 60 and the second lid 14 may include a catch 62 to lock the second lid 14 shut. The bin 48 includes a main handle 50 that provides an axis for the first lid 12 to rotate open approximately 270 degrees.

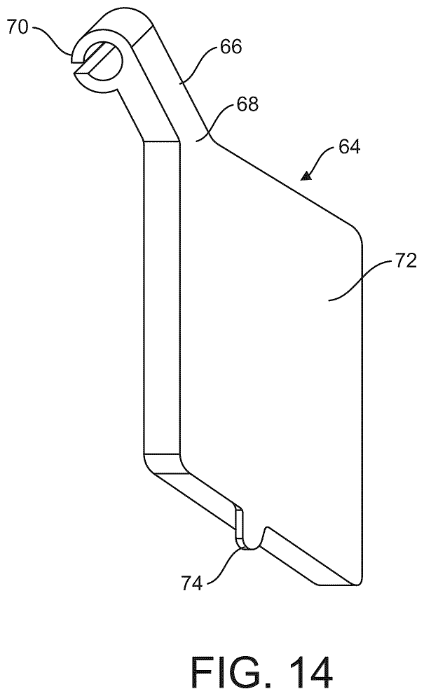

FIG. 14 is an elevated front quarter perspective view of an alternate embodiment of a second auxiliary lid 64 including a single hinge arm 66 of a unified one-piece construction with the auxiliary lid 64 that extends from a corner 68 of the lid 64 at an approximate 45-degree angle. The hinge arm 66 includes a snap-on “C” connector 70 at its end to make the lid 64 removably attachable to a first lid's recessed pin (not shown). However, the lid 64 may be removably attachable by any other suitable means to a first lid that allows the top surface of the first lid and the top surface 72 of the auxiliary lid 64 to be substantially level with each other when the auxiliary lid 64 is closed (not shown). The auxiliary lid 64 may include a tab 74 that is of a one-piece unified construction with the lid 64 that is used to open the lid 64.

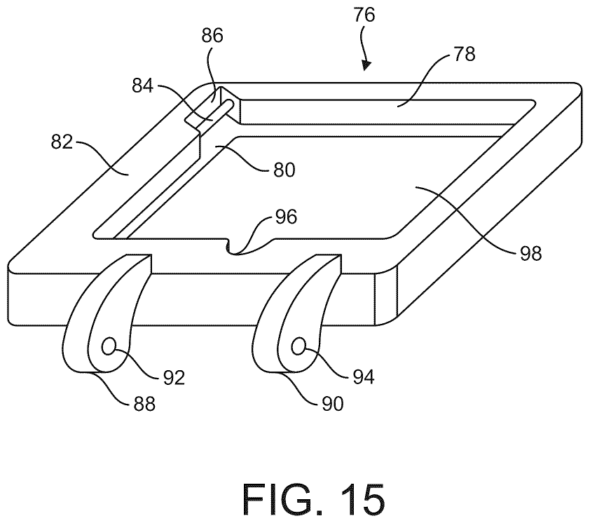

FIG. 15 is an elevated perspective view of an alternate embodiment of a hollowed first lid 76 for an auxiliary lid 64 (not shown). The hollowed first lid 76 includes a hollow 78 and a shelf 80 to allow the top surface of an auxiliary lid 64 to be substantially level with the top surface 82 of the hollowed first lid 76 when the auxiliary lid 64 is closed and attached to a pin 84 in a recess 86 that is adjacent to the hollow 78. The pin 84 allows an attached auxiliary lid 64 to rotate open in a direction that is different than the direction that the first hollow lid 76 opens when attached to a two wheeled trash bin 48 (not shown). The hollowed lid 76 may include two hinge arms 88 & 90 that are integrally formed with the lid 76, each further including a hole 92 & 94 that make the lid 76 removably attachable to a bin's main handle, to serve as a pin to form an axis for the lid 76 to rotate open and closed, at the back of a two wheeled bin (not shown). Further, the lid 76 may include a notch 96 so a user can conveniently access the tab 74 (not shown) of the attached auxiliary lid 64. The hollowed lid 76 further includes a hole 98 to deposit trash through when connected to a bin. The hole 98 is preferably large enough to accommodate a full, tall kitchen trash bag. The shelf 80 further acts to protect the pin 84 and C-shaped connector 70 (not shown) from falling trash when the lid 64 is inverted.

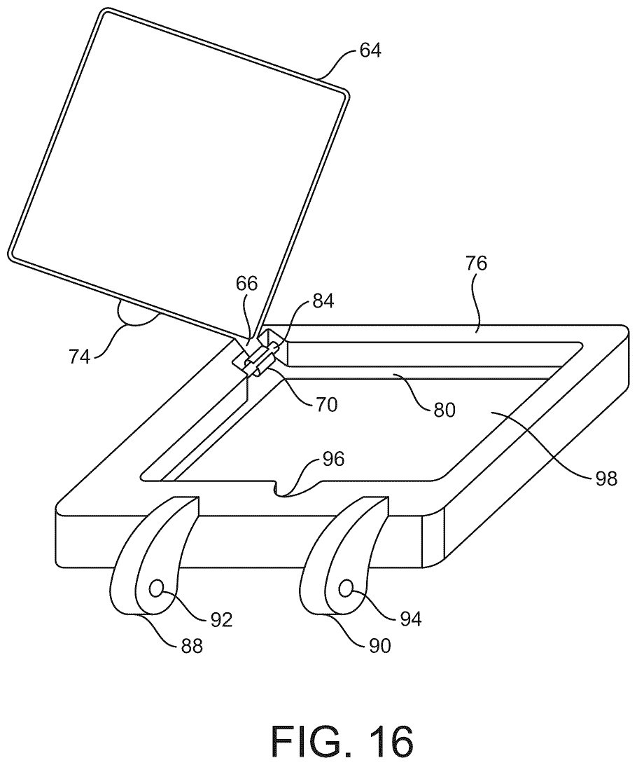

FIG. 16 is an elevated perspective view of an open auxiliary lid 64 attached to a hollowed first lid 76, where the hinged arm's 66 “C” connector 70 is removably attached to a recessed pin 84. Alternatively, the auxiliary lid 64 may be attached by a hinge arm 66 that includes a hole (as shown for the hinge arms 88 & 90 that each include a hole 92 & 94) that a pin 84 is inserted through to connect the auxiliary lid 64 to the hollowed lid 76. The auxiliary lid 64 covers and uncovers a hole 98 in the hollowed lid 76 and includes a tab 74 that may be used to open the lid 64.

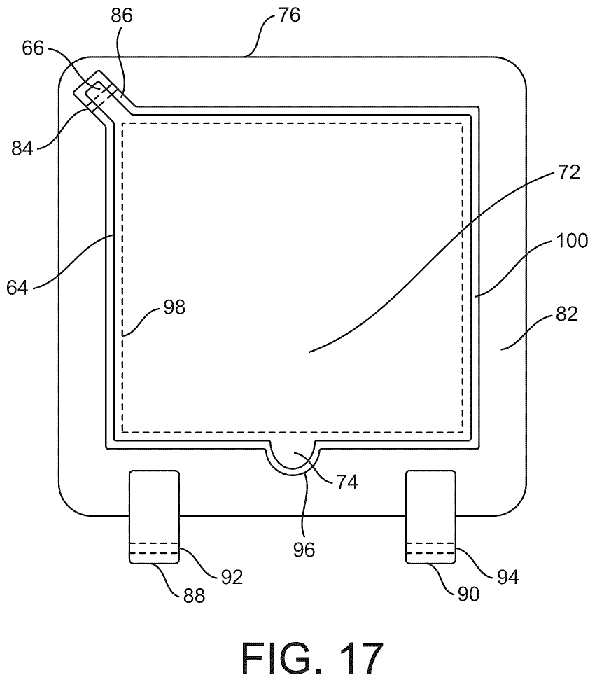

FIG. 17 is a top view of a FIG. 16 with the auxiliary lid 64 closed into the top 82 of the hollowed first lid 76. The hollowed lid 76 provides a space 100 that is greater in size than the hole 98, a shelf 80 for the auxiliary lid 64 to rest on, and a recess 86 for the hinge arm 66 to allow the auxiliary lid 64 to rest in the hollowed first lid 76 when closed, so that the auxiliary lid 64 covers the hole 98 and makes the top 72 of the auxiliary lid 64 substantially level with the top 82 of the hollowed lid 76. The hollowed lid 76 includes hinge arms 88 & 90, that further include a hole 92 & 94. Also, the hollowed lid 76 includes a notch 96 to create room for a user to access a tab 74 on the auxiliary lid 64 to open the lid 64.

Therefore, it must be understood that the illustrated embodiments have been set forth only for the purposes of examples and that they should not be taken as limiting the invention as defined by the following claims. For example, notwithstanding the fact that the elements of a claim are set forth below in certain combinations, it must be understood that the invention includes other combinations of fewer, more, or different ones of the disclosed elements.

Insubstantial changes from the claimed subject matter as viewed by a person with ordinary skill in the art, now known or later devised, are expressly contemplated as being equivalent within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted, and what incorporates the essential idea of the invention.

I claim:

1. A trash bin cover, comprising:
a cover for a cavity of a two wheeled trash bin,
the cover comprises a first lid useable to cover the bin's cavity; and
a second lid, removably attachable to the first lid, wherein the second lid is useable to cover and uncover a hole in the first lid to enable a user to deposit trash through the first lid's hole into the cavity of the two wheeled trash bin.

2. The first lid of claim 1, wherein the first lid is rotatable about an axis defined by the bin's main handle located at the back of the bin.

3. The first lid of claim 1, wherein the first lid further comprises a space to receive the second lid, so that the top surface of the second lid is substantially level with the top surface of the first lid when the second lid is closed to cover the hole in the first lid.

4. The second lid of claim 1, wherein the second lid is substantially parallel to the first lid when the second lid is attached to the top of the first lid and closed.

5. The second lid of claim 4, wherein the second lid is removably attachable to the top of the first lid by a hinge arm that is a one-piece unitary construction with the second lid.

6. The second lid of claim 1, wherein the second lid is removably attachable proximate to the front edge of the first lid.

7. The second lid of claim 1, wherein the second lid is removably attachable to a location on top of the first lid, the location being one of a group, the group further comprising the right-side edge or left side edge of the first lid.

8. The second lid of claim 1, wherein the second lid is rotatable about an axis not shared with the first lid that allows the second lid to open to approximately 180 degrees.

9. The second lid of claim 1, wherein the second lid further comprises a hinge arm that is of a one-piece unified construction with the second lid.

10. The cover of claim 1, wherein the cover further comprises a latch to secure the second lid shut to prevent the second lid from falling open when inverted.

11. The hole in the first lid of claim 1, wherein the hole is large enough to allow at least a full 4-gallon trash bag to be passed through it into the cavity of the two wheeled trash bin.

12. A cover for a wheeled trash bin, the cover comprising:
a cover for a cavity of a wheeled trash bin comprising two lids,
a first lid that further comprises a hole in its top, a hinge base member of a unified one-piece construction with the first lid; and
a second lid to cover and uncover the hole in the first lid, wherein the second lid comprises a hinge arm of a one-piece unified construction with the second lid that is removably attachable to the hinge base member of the first lid.

13. The first lid of claim 12, wherein the first lid is further able to rotate about an axis defined by the main handle of the wheeled trash bin.

14. The second lid of claim 12, wherein the second lid can be rotated open to approximately 180 degrees.

15. The second lid of claim 12, wherein the second lid can be rotated open in a back to front direction.

16. An auxiliary second lid for a wheeled trash bin, comprising:
an auxiliary second lid to cover and uncover a hole in a first lid for a two wheeled trash bin; and
the auxiliary second lid comprises a hinge arm of a unified one-piece construction that is removably attachable to the first lid.

17. The first lid of claim 16, further comprising a shelf to protect a pin of the first lid from falling trash.

18. The first lid of claim 16, wherein the first lid further comprises a space to receive the auxiliary lid in a way that the top surface of the auxiliary lid is substantially level with the top surface of the first lid when the auxiliary lid is attached to the first lid and closed to cover the hole in the first lid.

19. The first lid of claim 16, wherein the first lid further comprises a recess for the hinge arm.

20. The hinge arm of claim 16, wherein the hinge arm is further configured to attach to a recessed pin in the first lid.
